(19) United States
(12) Patent Application Publication
(10) Pub. No.: US 2026/0073660 A1
(43) Pub. Date: Mar. 12, 2026

(54) IMAGE PROCESSING APPARATUS, IMAGE PROCESSING METHOD, AND NON-TRANSITORY COMPUTER READABLE STORAGE MEDIUM

(71) Applicant: CANON KABUSHIKI KAISHA, Tokyo (JP)

(72) Inventor: KEITA NAKAGOMI, Tokyo (JP)

(21) Appl. No.: 19/324,813

(22) Filed: Sep. 10, 2025

(30) Foreign Application Priority Data
Sep. 11, 2024 (JP) 2024-157819

(51) Int. Cl. G06V 10/70; G06T 7/00; G06V 10/25

(52) U.S. Cl. CPC G06V 10/70; G06T 7/0012; G06V 10/25; G06T 2207/10081; G06T 2207/30008

(57) ABSTRACT

An image processing apparatus includes one or more memories that stores instructions and one or more processors that, upon execution of the instructions, operates as: an image acquisition unit, a region-of-interest setting unit, a processing target region setting unit, and an identification unit. The image acquisition unit acquires an image. The region-of-interest setting unit set a region of interest in the image. The processing target region setting unit sets a plurality of processing target regions for the region of interest. The identification unit performs an identification process on the plurality of processing target regions. The identification unit terminates the identification process when a predetermined termination condition is met.

### BACKGROUND

### Field of the Technology

The present disclosure relates to an image processing apparatus, an image processing method, and a program.

### Description of the Related Art

In the medical field, diagnoses are made using three-dimensional (3D) images acquired by a variety of image capturing apparatuses (modalities), such as a computed tomography apparatus (hereinafter referred to as a “CT apparatus”). In this diagnosis, the region of abnormality in the medical image data is detected. In recent years, the number of images has been increasing with the sophistication of image capturing apparatuses, resulting in an increased burden on diagnostic radiologists. Accordingly, a variety of techniques have been developed for automatic or semi-automatic detection and extraction of an abnormal region from images in order to reduce the diagnostic radiologist's workload.

One example is a technique that uses, as training data, a plurality of images and the region information regarding true abnormal regions (bone metastasis regions) in the captured images collected for a large number of cases and creates an inference engine that infers the abnormal region from images. For example, a technique has been proposed to construct a model by deep learning on the basis of the information about pixel values of the image in the training data and the information representing an abnormal region in the captured image. In this technique, the abnormal region information in a previously unseen input captured image is estimated (the region is extracted) on the basis of the learning model. In addition, a technique has been proposed that increases both the detection rate and specificity of the abnormal region by performing a two-step detection process.

However, according to the above technique, it is difficult to stable the detection rate in terms of setting of a processing target region during, in particular, the second inference in the abnormal region extraction process. In addition, the detection rate is not increased to the maximum.

### SUMMARY

The embodiments of the present disclosure provide extraction of an abnormal region included in medical image data more stably and with higher detection rate. However, the issues to be addressed by the embodiments of the present disclosure are not limited thereto. Issues corresponding to the effect of each of configurations described in the embodiments below can also be other issues.

According to an aspect of the present disclosure, there is provided an image processing apparatus including one or more memories storing instructions and one or more processors that, upon execution of the instructions, is configured to operate as: an image acquisition unit configured to acquire an image, a region-of-interest setting unit configured to set a region of interest in the image, a processing target region setting unit configured to set a plurality of processing target regions for the region of interest, and an identification unit configured to perform an identification process on the plurality of processing target regions, wherein the identification unit terminates the identification process when a predetermined termination condition is met.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of an example configuration of an image processing system that includes an image processing apparatus according to a first embodiment.

FIG. 2 is a flowchart of an example of the processing procedure for the image processing apparatus according to the first embodiment.

FIG. 3 illustrates an example of a cross-section of a CT image.

FIG. 4 illustrates an example of the result of a rough extraction process of a bone metastasis region in a CT image.

FIG. 5 illustrates an example of setting of an identification processing target region based on the result of the rough extraction process of a bone metastasis region.

FIG. 6 is a flowchart illustrating an example of the processing procedure for an image processing apparatus according to a second embodiment.

### DESCRIPTION OF THE EMBODIMENTS

Embodiments of an image processing apparatus, an image processing method, and a program are described in detail below with reference to the accompanying drawings,

### First Embodiment

An image processing apparatus according to the first embodiment is an apparatus for extracting a region from an image. The image processing apparatus has a function to extract the region of user's interest from an image. As used herein, the term “region of interest” also refers to information representing the contour shape of the region of interest. Furthermore, the image processing apparatus is characterized by performing a two-step inference process using an inference model constructed from training data, that is, performing second-step inference based on the result of first-step inference. According to the present embodiment, the image processing apparatus can provide the result of region extraction with high accuracy to the user.

According to the present embodiment, an example of extracting a bone metastasis region from a 3D CT image is described. However, even when the region is extracted from an image acquired from another type of modality or even when a region of another anatomical structure is extracted, the same effect of the present embodiment can be obtained by performing the same region extraction process.

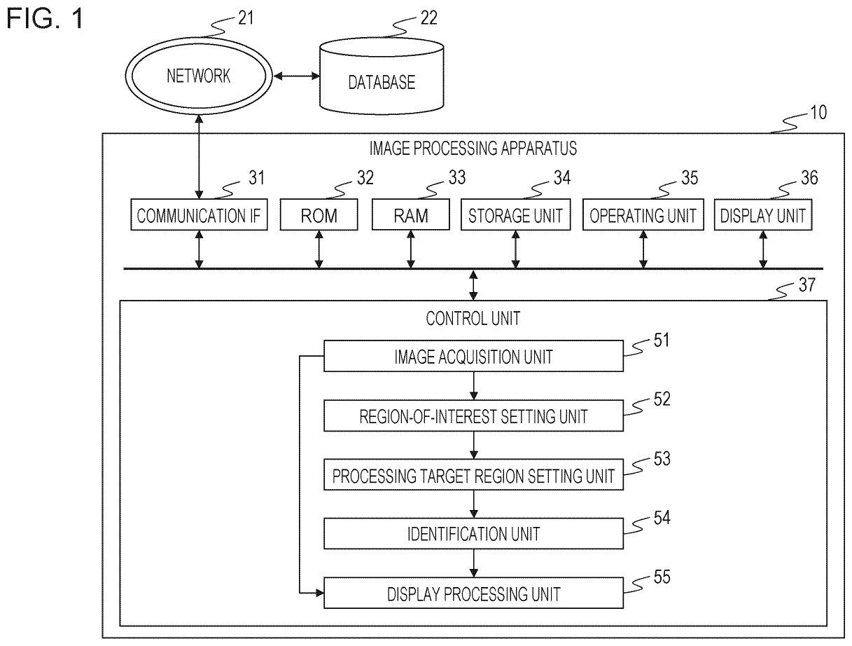

The configuration of the image processing apparatus according to the present embodiment and the processing performed by the image processing apparatus are described below with reference to FIG. 1. FIG. 1 is a block diagram of an example configuration of an image processing system (also referred to as a medical image processing system) including the image processing apparatus according to the first embodiment. The image processing system has, as the functional configuration thereof, an image processing apparatus 10, a network 21, and a database 22. The image processing apparatus 10 is connected to the database 22 via the network 21 so as to communicate with the database 22. Examples of the network 21 include a local area network (LAN) and a wide area network (WAN).

The database 22 stores and manages the images of the subjects and the information associated with the images. The information managed in the database 22 includes information for constructing a trained model calculated from a certain set of training data. The image processing apparatus 10 can retrieve information, such as the images, stored in the database 22 via the network 21.

The image processing apparatus 10 includes a communication interface (IF) 31 (a communication unit), a read only memory (ROM) 32, a random-access memory (RAM) 33, a storage unit 34, an operating unit 35, a display unit 36, and a control unit 37.

The communication IF 31 (the communication unit) is composed of a LAN card or the like and enables communication between an external device (for example, the database 22) and the image processing apparatus 10. The ROM 32 is composed of a nonvolatile memory or the like and stores variety of programs. The RAM 33 is composed of a volatile memory or the like and temporarily stores variety of types of information. The storage unit 34 is composed of a hard disk drive (HDD) or the like and stores a variety of type of information as data. The operating unit 35 is composed of a keyboard, a mouse, a touch panel, or the like and inputs an instruction from a user (for example, a diagnostic radiologist or a laboratory technician) to the various units.

The display unit 36 is composed of a display or the like and displays a variety of types of information to the user. The control unit 37 is composed of a central processing unit (CPU) or the like and performs overall control of the processing performed in the image processing apparatus 10. The control unit 37 has, as the functional constituent elements, an image acquisition unit 51, a region-of-interest setting unit 52, a processing target region setting unit 53, an identification unit 54, and a display processing unit 55.

The image acquisition unit 51 acquires an image to be processed from the database 22. That is, the image acquisition unit 51 is an example of an image acquisition unit. The image is the image of the subject acquired with one of a variety of modalities. According to the present embodiment, an example in which the image is a 3D CT image is described. However, the image may be any other type of image. The present embodiment is applicable to a 2D or higher dimensional image (for example, a plurality of 2D images, a 2D moving image, a 3D still image, a plurality of 3D images, or a 3D moving image). The present embodiment is also applicable regardless of the type of modality.

The region-of-interest setting unit 52 sets the contour information or coordinate information of the region of interest in the image acquired by the image acquisition unit 51. That is the region-of-interest setting unit 52 is an example of a region-of-interest setting unit.

The processing target region setting unit 53 sets a processing target region to be subjected to a subsequent identification process on the basis of the image acquired by the image acquisition unit 51 and the information of the region of interest set by the region-of-interest setting unit 52. That is, the processing target region setting unit 53 is an example of a processing target region setting unit.

The identification unit 54 performs an identification process on the basis of the image acquired by the image acquisition unit 51 and the information of the processing target region set by the processing target region setting unit 53. That is, the identification unit 54 is an example of an identification unit.

The display processing unit 55 displays an image, the contour information of the region of interest, and/or the result of identification in an easily recognizable display format within the image display area of the display unit 36 on the basis of the result calculated by the identification unit 54. That is, the display processing unit 55 is an example of a display unit.

Each of the above-described constituent elements of the image processing apparatus 10 operates according to a computer program, for example. For example, the function of each of the constituent elements is achieved by the control unit 37 (the CPU) that uses the RAM 33 as a work area and reads and executes a computer program stored in the ROM 32, the storage unit 34, or the like. The functions of some or all of the constituent elements of the image processing apparatus 10 may be achieved by using dedicated circuits. The functions of some of the constituent elements of the control unit 37 may be achieved by using a cloud computer.

For example, an arithmetic unit located at a different location from the image processing apparatus 10 may be connected to the image processing apparatus 10 via the network 21 so as to communicate with the image processing apparatus 10, and the functions of the constituent elements of the image processing apparatus 10 or the control unit 37 may be achieved by the arithmetic unit that communicates data with the image processing apparatus 10.

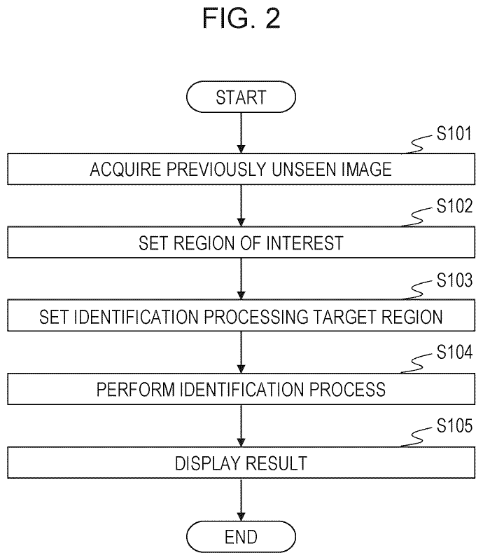

An example of the processing performed by the image processing apparatus 10 illustrated in FIG. 1 is described below with reference to FIG. 2.

FIG. 2 is a flowchart illustrating an example of the processing procedure for the image processing apparatus 10 according to the first embodiment. According to the present embodiment, an example of the case in which the bone metastasis region is defined as the region of interest is described. However, the present embodiment can also be applied to the case where another part, abnormal shadow, or a combination of a plurality of regions are defined as the region of interest.

### Step S101: Acquisition and Display of Image

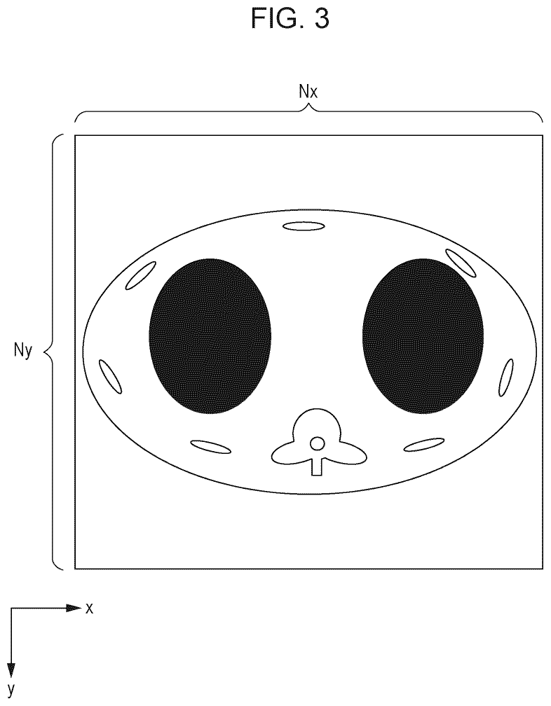

In step S101, when being instructed by the user to acquire an image via the operating unit 35, the image acquisition unit 51 acquires the image specified by the user from the database 22 and stores the image in the RAM 33. At this time, the display processing unit 55 may display the image in the image display area of the display unit 36. An example of the image is illustrated in FIG. 3. FIG. 3 illustrates an example where the image is a CT image. In the following description, the number of pixels in the x-direction and the number of pixels in the y-direction of the image are Nx and Ny, respectively. The number of pixels in the z-direction is Nz (the size in the z-direction is not illustrated in FIG. 3). That is, the total number of pixels of the image is Nx×Ny×Nz.

### Step S102: Setting of Region of Interest (Setting of Initial Region/Execution of Rough Extraction)

In step S102, the region-of-interest setting unit 52 sets the region of interest in the image acquired by the image acquisition unit 51. The process in step S102 corresponds to the preprocess of the identification process performed in the subsequent step and intends to extract, from the image, a candidate region that serves as an input to the identification process and set the region as a region of interest. This process corresponds to the first step (extraction processing) of the two-step abnormal region extraction process described in Noguchi et al. “Deep learning-based algorithm improved radiologists' performance in bone metastases detection on CT” Eur Radiol. 2022 November; 32 (11): 7976-7987. According to the present embodiment, the term “region of interest” refers to the result of rough extraction of a bone metastasis region in the CT image. A plurality of regions of interest may be set depending on the image. An example of bone metastasis is metastasis to the rib bone or the pelvis where an abnormal shadow is observed in a different region or location.

One example of a method for setting a region of interest is an automatic or semi-automatic segmentation method using one of machine learning models including a deep learning model. Alternatively, a region of interest may be extracted using an existing region extraction method, such as thresholding processing or graph cut segmentation.

According to the present embodiment, a method for setting a region of interest based on an automatic extraction process using a machine learning model is employed. In region extraction using a machine learning model, as a preparatory for region extraction, a model for extracting a bone metastasis region (a region of interest) is trained on the basis of training data. At this time, when supervised machine learning is employed, the training data consists of CT images and the information representing the bone metastasis region in the images (that is, true regions). The model is trained so as to automatically extract the true regions using the machine learning framework. Thereafter, by applying the trained model to a previously unseen image (an image not used in the training), a bone metastasis region in the previously unseen captured image can be automatically extracted. As an example, as described in Noguchi et al. “Deep learning-based algorithm improved radiologists' performance in bone metastases detection on CT” Eur Radiol. 2022 November; 32 (11): 7976-7987, an existing deep learning model, such as U-net, can be used for region extraction. However, the region extraction process may be performed using another deep learning model or a machine learning model other than a deep learning model (for example, a technique such as the support vector machine or boosting).

In step S102, when a machine learning model is used in the region-of-interest setting unit 52, a previously saved trained model can be read from the database 22 and used in the processing. That is, after acquiring the image in step S101, the region-of-interest setting unit 52 reads the trained model from the database 22, performs inference on the acquired image using the model and, then, sets the result of inference as the region of interest. More specifically, the region extracted as a bone metastasis region in the result of inference or the region with high likelihood and probability of bone metastasis extracted by thresholding processing or the like is set as a region of interest. According to the present embodiment, the information indicating the region of interest is information (an image) in which the region of interest contains pixels of pixel values of 1 or greater and the other region contains pixels of pixel values of 0. The information indicating the region of interest can be an image in which the pixels corresponding to the region of interest and other pixels can be distinguished in any way. Alternatively, the information indicating the region of interest may be the coordinate value of the region of interest or a list of a plurality of coordinate values of the region of interest in a 3D space.

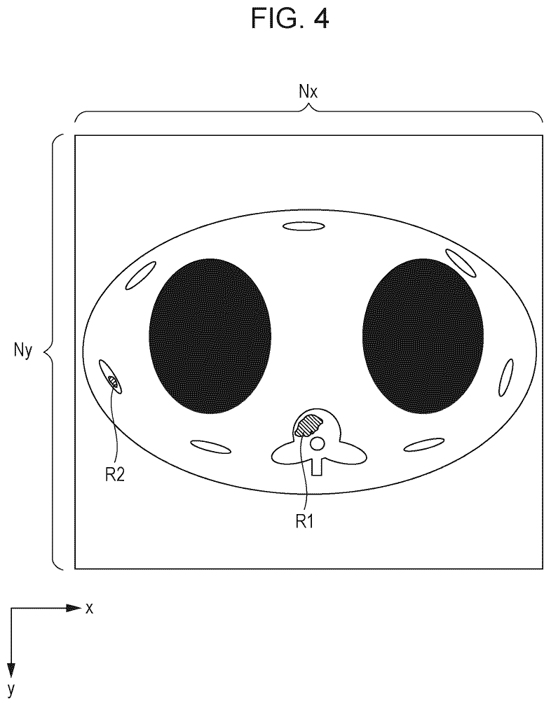

An example image is illustrated in FIG. 4. FIG. 4 illustrates an example in which, as a result of inference of regions of interest, shaded regions R1 and R2 are extracted as candidate bone metastasis regions from the CT image illustrated in FIG. 3 that serves as an input. According to the present embodiment, each of the regions R1 and R2 is set as an independent region of interest.

According to the present embodiment, the configuration for extracting and detecting a bone metastasis region through a two-step inference process is employed. That is, as in Noguchi et al. “Deep learning-based algorithm improved radiologists' performance in bone metastases detection on CT” Eur Radiol. 2022 November; 32 (11): 7976-7987, rough extraction is performed using U-net in the first step, and identification is performed using ResNet in the second step. Therefore, when the above-described deep learning model is trained or the parameters are adjusted during inference, it is desirable that adjustment be performed so that the number of true positives (bone metastasis regions) is maximized, while some false positives are allowed. The reason for this is that the identification process in the second step is based on the inference results of the first step and, if true positives are missed in the first step, it is difficult to detect a new region in the second step. That is, the first step is designed to minimize the number of missed true positives while minimizing the number of false positives, and the identification process is performed in the second step as an inference process to reduce the number of false positives. By dividing the inference-identification process into two steps, the training and inference process dedicated to the region of interest set through the inference in the first step can be performed and, thus, the inference accuracy can be improved.

The setting of the region of interest in step S102 may be input by the user via the operating unit 35, or the information representing the region of interest prestored in the database 22 may be read out.

### Step S103: Setting of Identification Processing Target Region

In step S103, the processing target region setting unit 53 sets the processing target region (that is, input data or an input image) to be processed in the identification process in step S104 (the second step of the inference process) on the basis of the region of interest set by the region-of-interest setting unit 52. In the present step, it is desirable to set the processing target region to maximize the identification accuracy while considering the inference process in step S104. The setting of a processing target region is performed for each of the regions of interest, and at least one processing target region is set for each of the regions of interest. More specifically, for example, a circumscribed cuboid of the region of interest may be set as the processing target region, or a cube or cuboid of a predetermined size centered at the centroid of the region of interest may be set as the processing target region (in the 3D case; a square or rectangle in the 2D case). Alternatively, a cube or cuboid of a predetermined size centered on a portion of the region of interest may be set as the processing target region. In this case, two or more cubes or cuboids of different sizes may be set as the processing target region, or two or more cubes or cuboids of the same size may be set as the processing target region. Furthermore, the shape of the processing target region is not limited to a cuboid but may be any shape.

As an example of a method for setting a processing target region, a method for setting a cubic processing target region using the information indicating the above-described region of interest in accordance with a predetermined algorithm is described below.

One example of the method for setting a processing target region is based on the distance from the contour of the region of interest. In the present example, the distance from the contour is measured such that the distance value at the location corresponding to the contour of the region of interest is defined as 0, and the distance value increases inward from the contour. In addition, the distance is measured by Euclidean distance. However, the measurement method may be any other existing measurement method, such as Manhattan distance. An example of the procedure for setting the processing target region is described below. If there are a plurality of regions of interest, the processing described below is performed independently for each of the regions of interest.

The distance of each of all of the pixels representing the region of interest to the contour of the region of interest is first calculated. Subsequently, among the pixels existing in the region of interest, a cubic region centered at the pixel having the greatest distance to the contour can be defined as the processing target region. When a plurality of processing target regions are set for a certain region of interest, the setting of the center position of the processing target region can be repeated on the basis of a predetermined condition and evaluation index. A particular example of the predetermined condition can include the following three items:
1. The pixel exists within a predetermined range.
2. The pixel is at least a predetermined distance away from the center of the processing target region that has already been set.
3. Among a set of the pixels that satisfy Items 1 and 2 above, the pixel has the greatest distance value to the contour.

The predetermined range in the above-described condition 1 may be the inside of the region of interest or the range within a predetermined distance from the farthest position from the contour of the region of interest. Alternatively, the range may be within a predetermined distance outward from the contour, or the range may be the entire range of the input image. The number of the plurality of processing target regions to be set can be determined by, after setting the above-described condition, adding a region until there are no more region that satisfies the above-described conditions. Alternatively, the setting may be repeated until a predetermined fixed number is reached or an upper limit is reached when the upper limit is set for the number.

In the above description, the processing target region is set based on the distance from the contour of the region of interest, but may be set based on other information of the region of interest. For example, the processing target region may be set based on the distance from the centroid of the region of interest or the distance from the center of the circumscribed cuboid of the region of interest. Alternatively, in terms of the result of extraction of the region of interest extracted in step S102, if the inferred value varies at different locations in the image, the processing target region may be set based on the inferred value. That is, when U-net is used for the first step of inference, the output value of U-net may be directly used as an evaluation index for setting the processing target region.

The above-described distance from the contour may be a signed distance. The distance from the contour to the inside of the region may be negative, and the distance from the contour to the outside of the region may be positive (or vice versa).

The effect of setting the processing target region, which is the input to the process in step S104, is described below with reference to the region of interest. As the characteristics of machine learning models, the inference accuracy tends to be high when a region to be extracted and identified is located near the center of the input data at the time of inference. In contrast, the inference accuracy tends to be low when the region is located at the edge of the input data. For this reason, if such a model is used in the second step of the two-step inference process, the inference accuracy in the second step can be improved by using the result of the first step (rough extraction of the region of interest).

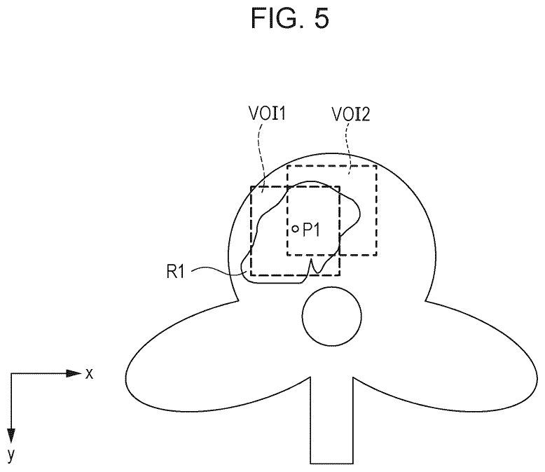

An example of the setting of a processing target region is illustrated in FIG. 5. FIG. 5 is a partially enlarged view of FIG. 4 and illustrates an example of setting, for a region of interest R1, volumes of interest VOI1 and VOI2, which are the processing target regions. Let P1 in FIG. 5 denote the position corresponding to the center of the volume of interest VOI1. Then, the above-described example of setting the processing target region corresponds to a method for setting the volume of interest VOI1 (or the position P1) at the location farthest from the contour of the region of interest R1 on the basis of the contour information of the region of interest R1. A plurality of processing target regions may also be set, as indicated by the volume of interest VOI2 illustrated in FIG. 5.

The effect of setting a plurality of processing target regions for a single region of interest is described below. In inference by machine learning models, even a slight change in the input image may result in a large change in the output. That is, even when processing target regions having the same size are set in close proximity, the identification results may differ from each other. Therefore, depending on how the processing target region is set, there is a risk that bone metastasis that would normally be determined to be positive will not be positive (will be missed). For this reason, a plurality of processing target regions can be set for a single region of interest obtained through inference in the first step, and the results for the processing target regions can be integrated to increase the stability and accuracy of the identification process. More specifically, to increase the detection rate of a bone metastasis region, a technique that uses the maximum, average, or median values of the plurality of identification results or a technique that takes a majority vote of the plurality of identification results can be employed.

### Step S104: Identification Process

In step S104, the identification unit 54 performs an identification process on the processing target region set by the processing target region setting unit 53. The automatic or semi-automatic segmentation method using a machine learning model including a deep learning model can also be used for the example of the identification process. Alternatively, an existing identification processing technique, such as a statistical model, may be used for identification. As in step S102, when using a machine learning model for the identification process, the trained model can be stored in the database 22 in advance and be used for the inference process (the identification process), and the same applies when using a statistical model. Hereinafter, description is made with reference to an example in which the identification process is performed on all of the processing target regions for a certain region of interest set in step S103. However, the identification process can be performed on some of the processing target regions. As described in Noguchi et al. “Deep learning-based algorithm improved radiologists' performance in bone metastases detection on CT” Eur Radiol. 2022 November; 32 (11): 7976-7987, an existing model, such as ResNet (Residual Neural Network), can be used in the identification process, for example.

In step S104, when a machine learning model is used in the identification unit 54, a previously stored trained model is read from the database 22, and an inference process is performed on all of the regions set as the processing target regions. When a plurality of regions are set as the processing target regions, the identification process can be performed on a certain region of interest by integrating the results of inference for the plurality of regions. In this case, the result of inference is a scalar value representing the likelihood or probability that the processing target region is positive for bone metastasis. To integrate the results of inference, a known statistical value, such as the maximum, median, average, or minimum value of the inference result, can be used. The integration process may use the results for all of the processing target regions set for a certain region of interest or only a top-ranked or bottom-ranked value of the data, such as a predetermined centile, in the calculation.

A particular example is the process of performing the identification process on the volumes of interest VOI1 and VOI2 set for the region R1 in FIG. 5, calculating the maximum value of the results of the identification process, and determining whether the region R1 is a bone metastasis region.

According to the present embodiment, a plurality of processing target regions are first determined in step S103 and, then, the identification process is performed in step S104. However, the flow of processing is not limited thereto. For example, each time a processing target region is set in step S103, the processing up to the identification process in step S104 is performed and, then, an inference processing target region different from the previously set inference processing target region is set in step S103 again. In this manner, the same effect can be obtained by repeating the setting of a processing target region and the identification process, as described above.

### Step S105: Displaying of Image Based on Identification Result

In step S105, the display processing unit 55 displays, in the image display area, the input image and the contour information of the region of interest identified as a positive bone metastasis region by the identification unit 54. At this time, the identified contour information and the image may be displayed in a superimposed manner. The superimposed display enables the user to easily observe both the region identified as a positive bone metastasis region and the image and, thus, the user can visually determine whether the result of the identification process is correct.

When the user intends to analyze or measure the region of interest, the processing in step S105 is not necessarily required, and the configuration may be such that the identification result in step S104 is saved. Alternatively, the configuration may be such that the identification results are displayed in step S105, and the user can select, from among the displayed identification results, the results to be saved and the results not to be saved.

While the example in which the image is a 3D image has been described above, the same processing can be performed even if the image is a 2D image.

According to present embodiment, a two-step inference process is performed using an inference model constructed from the training data, and second-step inference is performed on the basis of the result of the first-step inference, which has the effect of providing a more stable extraction result to the user.

While the first embodiment has been described above, the embodiment is not limited thereto and can be changed or modified as appropriate.

### Second Embodiment

According to the first embodiment, the example has been described in which a region of interest is set in step S102, an identification processing target region is set in step S103 on the basis of the region of interest, and the identification process is performed in step S104. This method improves the stability and accuracy of processing by setting a plurality of processing target regions for a certain region of interest. However, the method has a disadvantage in that increasing the number of identification processing target regions increases the computational cost. According to the second embodiment, an example of processing is described that reduces the computational cost by setting a plurality of processing target regions while maintaining the advantage that increases the stability of processing and the detection rate of abnormal shadows. While the present embodiment is described below with reference to a region of interest that is a bone metastasis region, the present embodiment is applicable to other regions and abnormal shadows.

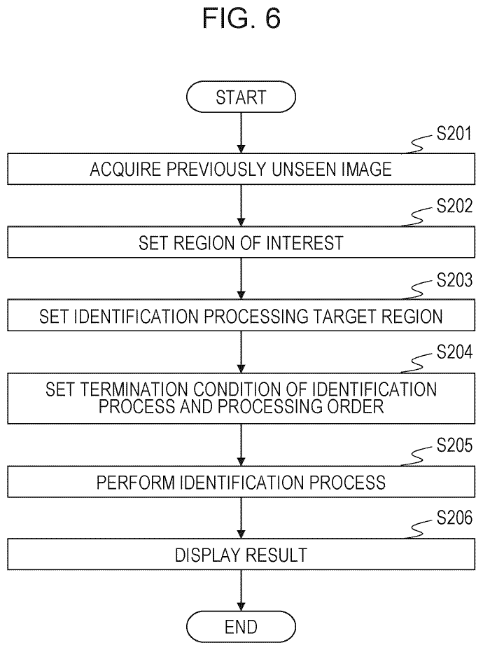

FIG. 6 is a flowchart illustrating an example of the processing procedure for an image processing apparatus 10 according to the second embodiment. In the steps of the illustrated flowchart, processing in steps S201 to S203 is similar to the processing in steps S101 to S103 according to the first embodiment illustrated in FIG. 2. In addition, processing in step S206 is similar to the processing in step S105 according to the first embodiment. That is, processing in only steps S204 and S205 differs from the processing according to the first embodiment. The differences from the first embodiment are described below.

### Step S204: Termination Condition of Identification Process and Setting of Processing Order

In step S204, the identification unit 54 sets the termination condition for the identification process performed on a processing target region set by the processing target region setting unit 53 and the processing order.

An example of setting the termination condition for the identification process will now be described and, thereafter, an example of setting the processing order is described below.

The termination condition for the identification process can be either a condition that terminates the process if positive bone metastasis is confirmed (a test-positive condition) or a condition that terminates the process if negative bone metastasis is confirmed (a test-negative condition) or both. A particular example of setting the termination condition is a method for setting a condition based on a predetermined threshold value. For example, as a test-positive condition, a condition can be set that terminates the identification process if the result of the identification process is greater than or equal to a predetermined threshold value (or is greater than a predetermined threshold value). Furthermore, the number of times this condition is met can be set. That is, the process may be terminated if the condition that the result of identification process for the processing target region is greater than or equal to the threshold value is met a predetermined number of times or more. For example, the termination condition is that the result of identification that meets a predetermined condition is obtained twice or more. On the other hand, as a test-negative condition, a condition can be set that terminates the identification process if the result of the identification process is less than or equal to a predetermined threshold value (or is less than a predetermined threshold value). Furthermore, the upper limit and the lower limit may be set for the predetermined threshold value. That is, the process may be terminated when the result of the identification process is greater than or equal to a predetermined threshold value (or is greater than a predetermined threshold value) or when the result is less than or equal to a predetermined threshold value (or is less than a predetermined threshold value). As described above, by setting the condition that terminates the process, the number of calculations can be reduced when the result of process that meets the condition is obtained, thus reducing the computational cost.

While the example in which the termination condition is set in the process in step S204 has been described, the processing performed by the image processing apparatus 10 may be started after the termination condition is set in advance. In addition, the termination condition may be changed in accordance with the region of interest set in step S202. More specifically, if the volume or area of the region of interest set in step S202 is large, a termination condition may be set. Otherwise, no termination condition may be set. Alternatively, for example, it is possible to determine whether to set a termination condition on the basis of the number of the identification processing target regions set in step S203. For example, if the number of the identification processing target regions is less than a predetermined number, no termination condition may be set. It is also possible to automatically set a termination condition when there are images waiting to be processed by the image processing apparatus 10 and not set a termination condition when there are no images waiting to be processed. The user may be allowed to select whether to set a termination condition.

The setting of the processing order is described below. In the identification process performed in step S205, the computational cost may be further reduced by a combination of the above-described setting of the termination condition and determination of the order in which the processes are performed. For example, if the order can be set so that the location most likely to be identified as a positive bone metastasis location is processed first when a positive test for bone metastasis is conducted, the effect of reducing the computational cost is enhanced. That is, in the case where a termination condition that terminates the identification process if tested positive (for example, if the result of inference is greater than or equal to a certain threshold value) is set and, then, the identification process is performed on a plurality of processing target regions, if it is determined earlier that the test result is positive, the computational cost can be reduced.

An example of the above-described method for setting the processing order is a method for determining the processing order in which the processing target regions are processed based on a predetermined evaluation function, like the method used by the processing target region setting unit 53 in step S203. More specifically, for example, the distance from the contour of the region of interest centered at the center of the processing target region can be used as the evaluation value, and the identification process can be performed on the processing target regions, in descending order of distance of the processing target region. The reason for this is that as the characteristics of machine learning models, the inference accuracy tends to be high when a region to be extracted and identified is located near the center of the input data at the time of inference and, therefore, the computational cost is likely to be reduced by first processing the processing target region set near the center.

While the present embodiment has been described with reference to the evaluation function based on the distance from the contour of the region of interest, other information regarding the region of interest can be used as the evaluation value, as described in step S203. For example, the distance from the center of the circumscribed cuboid, the distance from the centroid of the region of interest, or the extraction result of the region of interest extracted in step S202 (the inferred value by U-net) can be used as the evaluation value. Alternatively, an evaluation value obtained by integrating some of these evaluation values may be used.

Alternatively, the processing for the locations that are far from each other (for example, the center and an endpoint) may be performed first and, thereafter, the processing for the locations that are gradually closer to each other may be performed.

The setting of the processing order need not be always performed, and the identification processes of the processing target regions may be performed in the order of image scanning (the raster scan order) or in a random order. If the processing can be terminated when a predetermined condition is met, the effect of reducing the computational cost is maintained.

### Step S205: Identification Process

In step S205, the identification unit 54 performs the identification process on the processing target region set by the processing target region setting unit 53 in the same manner as in step S104 according to the first embodiment.

However, unlike the first embodiment, when the identification process is performed, the process is terminated on the basis of the condition set in step S204. That is, the identification unit 54 according to the present embodiment further has a function to terminate the identification process when the inference result of the set processing target region meets a predetermined condition. Furthermore, if the order of the identification process is determined in step S204, the identification process is performed according to that order. If the order is not determined, the identification process can be performed in any order.

An example of the detection process to detect a bone metastasis region according to the first embodiment is described below. According to the first embodiment, to increase the detection rate of a bone metastasis region, a plurality of identification processing target regions are set for a certain region of interest, and the maximum value of the identification results is adopted. At this time, if the maximum value is greater than or equal to a predetermined threshold value in the positive/negative test for the bone metastasis region, it is determined that bone metastasis is positive. If the above-described determination condition is set in the termination condition for the identification process in step S204, the result of the positive/negative test conducted for the region of interest is completely the same regardless of whether termination of the identification process occurs or not. This also enables reduction in the number of calculations for the identification processing target region. As a result, the effect of reducing the computational cost is obtained while maintaining the effect of increasing the detection rate in the bone metastasis region detection process according to the first embodiment.

The effect is described below that is obtained by providing a lower limit as the termination condition of the identification process in the example in which the maximum value for the plurality of identification processing target regions is employed. The effect reduces the computational cost when the region of interest is negative for bone metastasis. A classifier that conducts a positive test for bone metastasis is trained such that when the processing target region is set at a bone metastasis-negative location, the inference result (inferred value) is lower than that at a bone metastasis-positive location. That is, a sufficiently low inferred value obtained suggests that the region of interest is negative for bone metastasis. Therefore, it can be determined that the region of interest is negative for bone metastasis, and the process can be terminated. This can reduce the number of calculations for the identification processing target region. However, if a lower limit is set in the termination condition, the result of the positive/negative test of the region of interest changes depending on the presence or absence of the condition. This is because it is not guaranteed that the value of the inference result for the processing target region that is processed first is greater than the value of the inference result for the processing target region that is subsequently processed. However, as described in step S204, this risk can be reduced by setting an appropriate identification processing order for the processing target regions. That is, by performing the inference for the processing target regions in the order in which the value of the inference result is likely to increase, the risk of incorrectly determining a region of interest that is true positive as negative and terminating the processing is minimized, and high-speed processing can be expected.

Both the upper and lower limits of the above-described termination condition may be set as the condition. In this case, since the effect of reducing the computational costs by both can be achieved, further speedup can be expected.

In the above example, when it is determined whether a certain region of interest is positive or negative for bone metastasis, the case where the determination process for the region of interest is terminated has been described. However, the present embodiment is not limited thereto. For example, when only one identification result is required for the entire input image, the termination condition may be set across a plurality of regions of interest. For example, when it is determined whether the entire input image is positive or negative for bone metastasis (determination on a per-case basis), the processing of the entire image (processing of all regions of interest) may be terminated when any of the processing target regions is determined to be positive. In this case, in terms of determination of the processing order made in step S204, if a plurality of regions of interest are present, the processing order can be determined for the plurality of regions of interest. For example, in the processing order for a plurality of regions of interest, the region of interest with a higher likelihood/probability of being positive can be ranked high on the basis of the result of processing performed in step S202. Alternatively, the region of interest with a larger region size may be ranked high. Thereafter, the processing order may be determined for each of the regions of interest in each of the above-described manners. Alternatively, the order of the identification process may be determined after combining the processing target regions for a plurality of regions of interest.

While the above embodiment has been described with reference to the example in which both the termination condition of the identification process and the processing order are set in step S204, either one of the two settings may be performed.

The processing according to the second embodiment is performed according to the processing procedure described above. This exhibits the effect of extracting an abnormal region in medical image data more stably, at a higher detection rate, and at a lower computational cost.

According to the embodiment described above, the identification unit 54 performs positive/negative test of a specific anatomical structure, such as positive/negative test for bone metastasis, as an identification process for a processing target region set by the processing target region setting unit 53. However, the present embodiment is not limited thereto. For example, the identification unit 54 may perform, as the identification process, a process other than the positive/negative test process of anatomical structures on a processing target region set by the processing target region setting unit 53. For example, the identification unit 54 may perform, as the identification process, a segmentation process of a specific anatomical structure on a processing target region set by the processing target region setting unit 53.

While an example of the embodiment has been described above, the technology of the present disclosure is not limited to the embodiment described above with reference to the accompanying drawings, but can be implemented with appropriate modification within the spirit and scope of the present disclosure.

### OTHER EMBODIMENTS

The disclosed technology can be implemented as a system, an apparatus, a method, a program, or a recording medium (storage medium), for example. More specifically, the technology can be applied to a system including a plurality of devices (for example, a host computer, an interface device, an image capture device, a web application, and the like) or to an apparatus consisting of a single device.

The purpose of the technology described herein can also be achieved by a recording medium (or storage medium) described below. That is, a computer-readable recording medium storing software program code (a computer program) that provides the functions of the above-described embodiments is supplied to a system or an apparatus. A computer (a CPU) or a micro processing unit (MPU)) of the system or apparatus then reads and executes the program code stored in the recording medium. In this case, the program code read from the storage medium itself achieves the functions of the above-described embodiments, and the recording medium storing the program code constitutes the technology disclosed herein.

According to the embodiments described above, the control unit 37 is composed of a processing circuit, such as a processor. In this case, the function of each of the processing units described above are stored in the ROM 32 in the form of a program executable by a computer. The control unit 37 then reads and executes each of the programs stored in the ROM 32 to provide the function corresponding to the program. That is, the control unit 27 that has read the programs includes the processing units illustrated in FIG. 1.

In above description of the embodiments, the image acquisition unit, the region-of-interest setting unit, the processing target region setting unit, and the identification unit of the present disclosure are implemented as the image acquisition unit 51, the region-of-interest setting unit 52, the processing target region setting unit 53, and the identification unit 54 of the control unit 37, respectively. However, the embodiments are not limited thereto. For example, instead of being implemented using the image acquisition unit 51, the region-of-interest setting unit 52, the processing target region setting unit 53, and the identification unit 54 of the control unit 37 described in the embodiments, the image acquisition unit, the region-of-interest setting unit, the processing target region setting unit, and the identification unit of the present disclosure can be implemented using only hardware, only software, or a combination of hardware and software that provides the same function.

According to the embodiments described above, the control unit 37 is not necessarily composed of a single processor. For example, the control unit 37 may be composed of a combination of a plurality of independent processors, each executing a program to provide the function of one processing unit. The function of each of the processing units of the control unit 37 may be achieved by a single processing circuit or a plurality of processing circuits in an appropriate distributed or integrated manner. The function of each of the processing units of the control unit 37 may also be achieved by a combination of hardware, such as a circuit, and software. While the example in which the programs each corresponding to the function of one of the processing units are stored in the single ROM 32 has been described above, the embodiment is not limited thereto. For example, the programs each corresponding to the function of one of the processing units may be stored in a plurality of storage circuits in a distributed manner, and the control unit 37 may read and execute each of the programs in the corresponding one of the storage circuits.

In the above-described embodiments, the term “processor” refers to a circuit, such as a CPU, a graphics processing unit (GPU), an application specific integrated circuit (ASIC), a programmable logic device (for example, a simple programmable logic device (SPLD), a complex programmable logic device (CPLD), or a field programmable gate array (FPGA)). Instead of storing the program in a storage circuit, the program can be embedded directly into the circuitry of the processor. In this case, the processor reads and executes the program embedded in the circuit to provide the function. Each of the processors according to the present embodiments is not limited to a processor configured as a single circuit, but may be a processor configured by combining a plurality of independent circuits to achieve the function.

According to the embodiments described above, each of the constituent elements of each of the apparatuses illustrated in the drawings is a functional element, and does not necessarily have to be a physical element configured as illustrated in the drawings. That is, the apparatuses need not be distributed or integrated as illustrated, and all or some of the apparatuses can be distributed or integrated into any groups in accordance with a various type of loads or the usage conditions. In addition, all or some of the processing functions provided by the apparatuses can be achieved by a CPU and the program analyzed and executed by the CPU or hardware using wired logic.

Of the processes described in the embodiments and modifications above, all or some of the processes described as being performed automatically can be performed manually, or all or some of the processes described as being performed manually can be performed automatically by known methods. In addition, the processing procedures, control procedures, specific names, and the information including a variety of data and parameters described in the above document and drawings can be changed as desired, unless otherwise noted.

The variety of data presented herein are typically digital data.

According to at least one of the embodiments described above, an abnormal region in medical image data can be extracted more stably and with a higher detection rate.

Although several embodiments have been described, these embodiments are presented as examples and are not intended to limit the scope of the disclosure. These embodiments can be implemented in various other forms, and various omissions, substitutions, modifications, and combinations of embodiments can be made without departing from the gist of the disclosure. The embodiments and modifications thereof are included within the scope of the claims and their equivalents as well as within the scope and gist of the disclosure.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-157819, filed Sep. 11, 2024, which is hereby incorporated by reference herein in its entirety.

What is claimed is:

1. An image processing apparatus comprising:
one or more memories storing instructions; and
one or more processors that, upon execution of the instructions, is configured to operate as:
an image acquisition unit configured to acquire an image;
a region-of-interest setting unit configured to set a region of interest in the image;
a processing target region setting unit configured to set a plurality of processing target regions for the region of interest; and
an identification unit configured to perform an identification process on the plurality of processing target regions,
wherein the identification unit terminates the identification process when a predetermined termination condition is met.

2. The image processing apparatus according to claim 1, wherein the identification unit performs the identification process in accordance with a processing order of the plurality of processing target regions determined based on a predetermined evaluation function.

3. The image processing apparatus according to claim 1, wherein the processing target region setting unit sets the plurality of processing target regions based on a distance from a contour of the region of interest.

4. The image processing apparatus according to claim 2, wherein the predetermined evaluation function evaluates a distance from a contour of the region of interest, and
wherein the identification unit determines the processing order of the plurality of processing target regions based on an evaluation result of the predetermined evaluation function.

5. The image processing apparatus according to claim 1, wherein the predetermined termination condition includes either a test-positive condition for determining that a result of the identification process is test-positive or a test-negative condition for determining that a result of the identification process is test-negative, and
wherein the predetermined termination condition terminates the identification process if the test-positive condition is met or if the test-negative condition is met.

6. The image processing apparatus according to claim 5, wherein the test-positive condition is a condition that terminates the identification process if the result of the identification process is greater than or equal to a predetermined threshold value.

7. The image processing apparatus according to claim 5, wherein the test-negative condition is a condition that terminates the identification process if the result of the identification process is less than a predetermined threshold value.

8. The image processing apparatus according to claim 1, wherein the predetermined termination condition includes both a test-positive condition for determining that a result of the identification process is test-positive and a test-negative condition for determining that a result of the identification process is test-negative, and
wherein the predetermined termination condition terminates the identification process if the test-positive condition is met or if the test-negative condition is met.

9. An image processing method comprising:
acquiring an image;
setting a region of interest in the image;
setting a plurality of processing target regions for the region of interest; and
performing an identification process on the plurality of processing target regions,
wherein in the performing an identification process, the identification process is terminated when a predetermined termination condition is met.

10. The image processing method according to claim 9, wherein in the performing an identification process, the identification process is terminated in accordance with a processing order of the plurality of processing target regions determined based on a predetermined evaluation function.

11. The image processing method according to claim 9, wherein in the setting a plurality of processing target regions, the plurality of processing target regions are set based on a distance from a contour of the region of interest.

12. The image processing method according to claim 10, wherein the predetermined evaluation function evaluates a distance from a contour of the region of interest, and
wherein in the performing an identification process, the processing order of the plurality of processing target regions is determined based on an evaluation result of the predetermined evaluation function.

13. The image processing method according to claim 9, wherein the predetermined termination condition includes either a test-positive condition for determining that a result of the identification process is test-positive or a test-negative condition for determining that a result of the identification process is test-negative, and
wherein the predetermined termination condition terminates the identification process if the test-positive condition is met or if the test-negative condition is met.

14. The image processing method according to claim 13, wherein the test-positive condition is a condition that terminates the identification process if the result of the identification process is greater than or equal to a predetermined threshold value.

15. The image processing method according to claim 13, wherein the test-negative condition is a condition that terminates the identification process if the result of the identification process is less than a predetermined threshold value.

16. The image processing method according to claim 9, wherein the predetermined termination condition includes both a test-positive condition for determining that a result of the identification process is test-positive and a test-negative condition for determining that a result of the identification process is test-negative, and
wherein the predetermined termination condition terminates the identification process if the test-positive condition is met or if the test-negative condition is met.

17. A non-transitory computer readable storage medium storing a computer program that, when executed by one or more processors of a computer, causes the computer to execute a method comprising:
acquiring an image;
setting a region of interest in the image;
setting a plurality of processing target regions for the region of interest; and
performing an identification process on the plurality of processing target regions,
wherein in the performing an identification process, the identification process is terminated when a predetermined termination condition is met.
